(19) United States
(12) Patent Application Publication
(10) Pub. No.: US 2014/0002373 A1
(43) Pub. Date: Jan. 2, 2014

(54) DISPLAY FOR ELECTRONIC DEVICE

(71) Applicant: NICHOLAS W. OAKLEY, Portland, OR (US)

(72) Inventor: NICHOLAS W. OAKLEY, Portland, OR (US)

(21) Appl. No.: 13/537,357

(22) Filed: Jun. 29, 2012

(51) Int. Cl. G06F 3/01; G06F 3/041

(52) U.S. Cl. 345/173; 345/156

(57) ABSTRACT

In one embodiment an electronic device comprises a housing having a first section and a second section comprising a display, the second section coupled to the first section by a hinge assembly, a housing having a first section and a second section comprising a display, the second section coupled to the first section by a hinge assembly a hinge assembly, wherein the hinge assembly provides rotational motion between the first section and the second section about a longitudinal axis, a translation assembly to provide lateral translation of the second section between a first position and a second position, relative to the first section, and a controller to detect lateral translation of the second section of the housing from the first position to the second position and in response thereto, to activate an ancillary display device coupled to the housing. Other embodiments may be described.

### BACKGROUND

The subject matter described herein relates generally to the field of electronic devices and more particularly to a display assembly for one or more electronic devices.

Many electronic devices incorporate network interface cards or other network access technology which permits the devices to remain connected to an electronic communication network even when in a low-power operating state. This feature is sometimes referred to as “always on, always connected” or by the acronym AOAC, and enables an electronic device to receive network-based information updates such as electronic mail, status updates, and the like even when the device is in a low-power operating mode.

Further, some electronic devices utilize a “clamshell” housing. By way of example, many laptop computers and mobile electronic devices utilize a clamshell housing in which a keyboard and/or other input/output mechanisms are disposed on a first section and a display is disposed on a second section coupled to the first section, typically by a hinge. Alternatively, a “clamshell” can consist of displays, one on a first section that can also be utilized as a touch keyboard and one display on a second section coupled to the first section by a hinge. Electronic devices with clamshell housings are commonly designed to switch automatically to a low-power state when the clamshell housing is closed and to revert automatically to a power-on state when the clamshell housing is opened.

Users of electronic devices may wish to check the status of network-based information updates on a periodic basis. In most electronic devices this requires waking the electronic device to a full power-on state such that the device's display may be activated to present information updates. For example, in most laptops this requires opening the clamshell housing of the laptop computer.

Accordingly techniques to enable electronic devices to present network based information updates efficiently may find utility.

### BRIEF DESCRIPTION OF THE DRAWINGS

The detailed description is described with reference to the accompanying figures.

FIG. 1 is a schematic illustration of an exemplary electronic device which may be adapted to implement a display assembly in accordance with some embodiments.

FIG. 2 is a high-level schematic illustration of an architecture of an exemplary electronic device which may be adapted to implement a display assembly in accordance with some embodiments.

FIGS. 3A-3C are schematic, perspective views of an electronic device in accordance with some embodiments.

FIGS. 4A-4C are schematic, perspective views of an electronic device in accordance with some embodiments.

FIGS. 5A and 5B are schematic illustrations of a hinge assembly in accordance with some embodiments.

FIG. 6 is a flowchart illustrating operations of a controller in a method to implement a display assembly in accordance with some embodiments.

FIG. 7 is a schematic illustration of an exemplary electronic device which may be modified to include a locking hinge assembly in accordance with some embodiments.

FIGS. 8A and 8B are schematic, perspective views of an electronic device in accordance with some embodiments.

### DETAILED DESCRIPTION

Described herein are exemplary systems and methods to lock, or at least to inhibit the rotation of a display on a clamshell housing. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

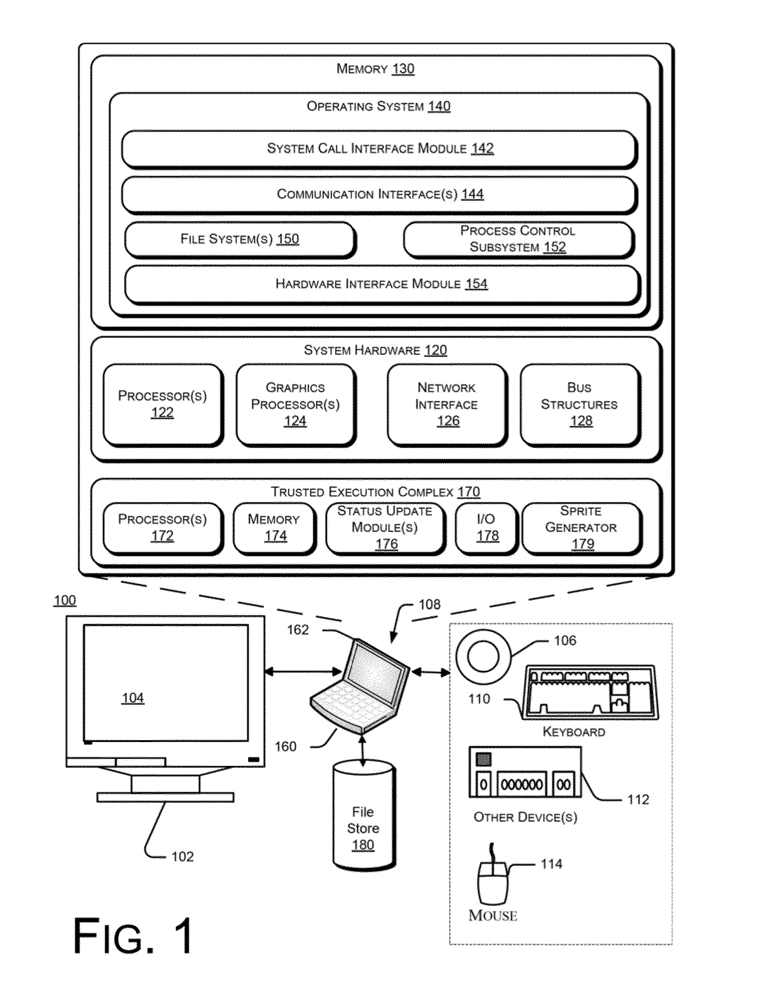

FIG. 1 is a schematic illustration of an exemplary system 100 which may be adapted to implement a display for an electronic device in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/0 device(s) 112 may include a touch screen, a voice-activated input device, a track ball, a geolocation device, an accelerometer/gyroscope and any other device that allows the system 100 to receive input from a user and to show context of use.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated into the packaging of processor(s) 122, onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part H: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments system 100 may comprise a low-power embedded processor, referred to herein as a trusted execution complex 170. The trusted execution complex 170 may be implemented as an independent integrated circuit located on the motherboard of the system 100. In the embodiment depicted in FIG. 1 the trusted execution complex 170 comprises a processor 172, a memory module 174, a status update module 176, an I/O module 178, and a secure sprite generator 179. In some embodiments the memory module 174 may comprise a persistent flash memory module and the authentication module 174 may be implemented as logic instructions encoded in the persistent memory module, e.g., firmware or software. The I/O module 178 may comprise a serial I/O module or a parallel I/O module. Because the trusted execution complex 170 is physically separate from the main processor(s) 122 and operating system 140, the trusted execution complex 170 may be made secure, i.e., inaccessible to hackers such that it cannot be tampered with by users or processes executing on operating system 140.

In some embodiments the trusted execution complex 170 may manage processes to receive and present network-based information updates. FIG. 2 is a high-level schematic illustration of an architecture of an exemplary electronic device which may be adapted to implement a display assembly in accordance with some embodiments. Referring to FIG. 2, electronic device 108 may be characterized as having an untrusted execution complex and a trusted execution complex. When the electronic device 108 is embodied as a system 100 the trusted execution complex may be implemented by the trusted execution complex 170, while the untrusted execution complex may be implemented by the main processors(s) 122 and operating system 140 of the system 100.

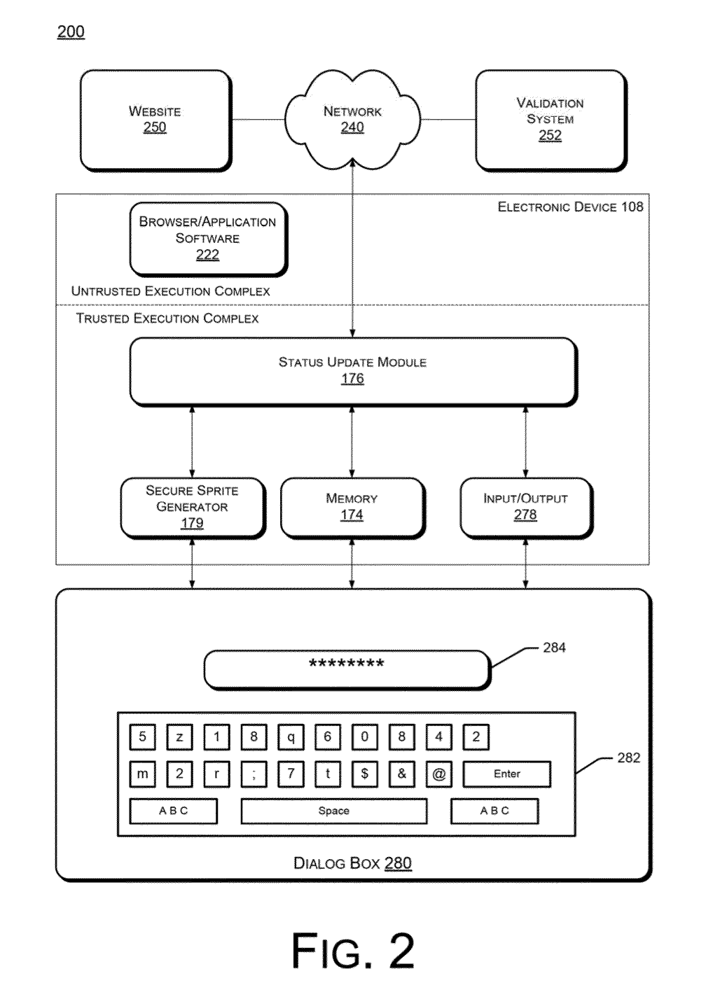

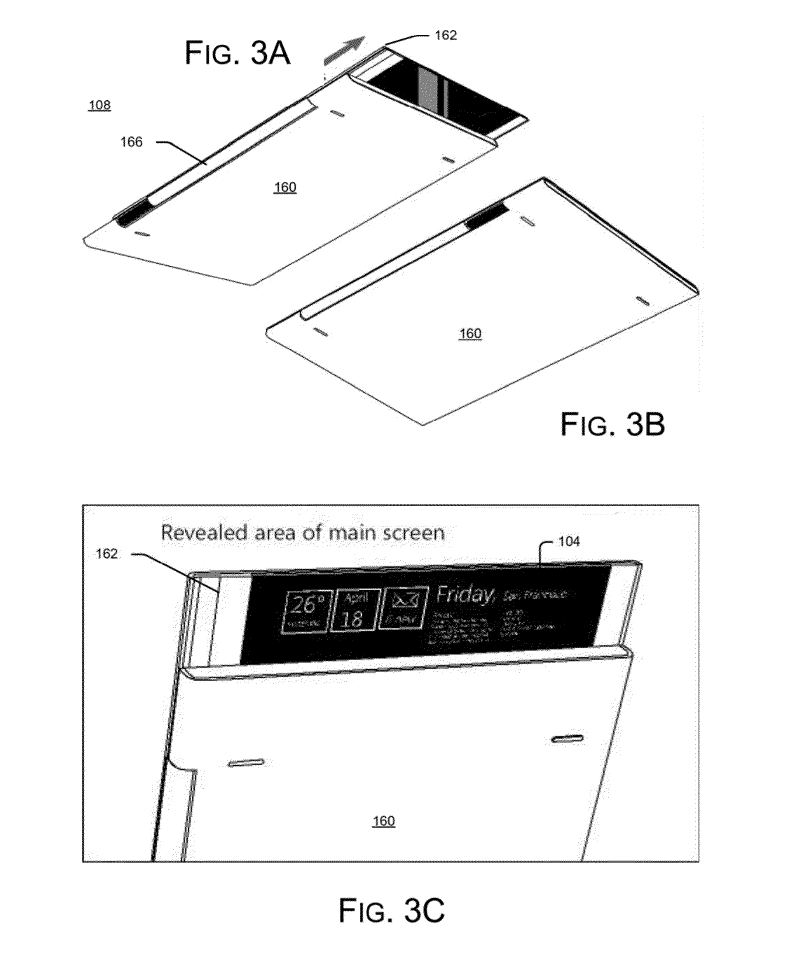

As illustrated in FIG. 3, remote entities that originate transactions, may be embodied as websites or the like and may be coupled to the electronic device 108 via a communication network 240. In use, an owner or operator of electronic device 108 may register with a website 250 using a browser 222 or other application software via the network 240. A validation system 252 may be associated with, or communicatively coupled to, website 250. In some embodiments the validation system may request or require a user to provide an secure credential, such as a username/password combination or the like. Once registered, the website 250 or validation system 252 may pass a token to the electronic device. 108 which enables the electronic device 108 to access information from the website without registering every time. The token may be stored in a memory, such as memory 174. In some embodiments the website may push new information to the electronic device. However, in most embodiments the electronic device 108 may request information updates from the website 250.

The architecture of FIG. 2 permits an electronic device 108 to implement operations to receive network-based information updates from a remote source such as website 250 even while the untrusted execution complex is in a low-power state. In response to a user input, the trusted execution complex may generate a dialog box on a portion of the display of the electronic device and present updated status information on the dialog box. By way of example, in some embodiments the status update module 176 executing on processor 172 may receive network-based information updates such as, e.g., electronic mail, status updates from social networking applications, stock prices, weather information, and the like. The information updates may be stored, at least temporarily, in memory 174. In response to a user input, the sprite generator 179 may generate a dialog box 280 on a portion of the display of electronic device 108. The dialog box 280 may present one or more input mechanisms 282 which may receive user input such as a login password, which may be presented in a window 284. Assuming a successful login, one or more network-based information updates may be presented on the dialog box 280.

FIGS. 3A-3C are schematic, perspective views of an electronic device in accordance with some embodiments. Referring to FIGS. 3A-3C, in some embodiments an electronic device 108 may be embodied as a laptop computer or the like, as described with reference to FIG. 1. In some embodiments the electronic device 108 includes a housing having a base, or a first section 160, and second section 162 which includes the display 104 of the device. As illustrated with reference to FIGS. 3A-3C, in some embodiments the first section 160 of the housing is joined to the second section 162 by a hinge assembly 166 which provides rotational motion about a longitudinal axis to enable the first section 160 and the second section 162 to open and close in a clamshell fashion. Further, in some embodiments the hinge assembly 166 provides lateral translation between the first section 160 and the second section 162 along the longitudinal axis between a first position, illustrated in FIG. 3B, in which the housing is closed, and a second position, illustrated in FIG. 3A, in which a portion of the second section extends beyond the edge of the first section 160, thereby exposing a portion of the display 104 which may be used to present network-based information updates.

FIGS. 4A-4C are schematic, perspective views of an electronic device in accordance with some embodiments. In the embodiments depicted in FIGS. 4A-4C the hinge assembly 166 enables both rotational motion and lateral translation, as described with reference to FIGS. 3A-3C. However, the first section 160 includes an ancillary display 104 which is exposed when the second section 162 is translated laterally with respect to the first section 160.

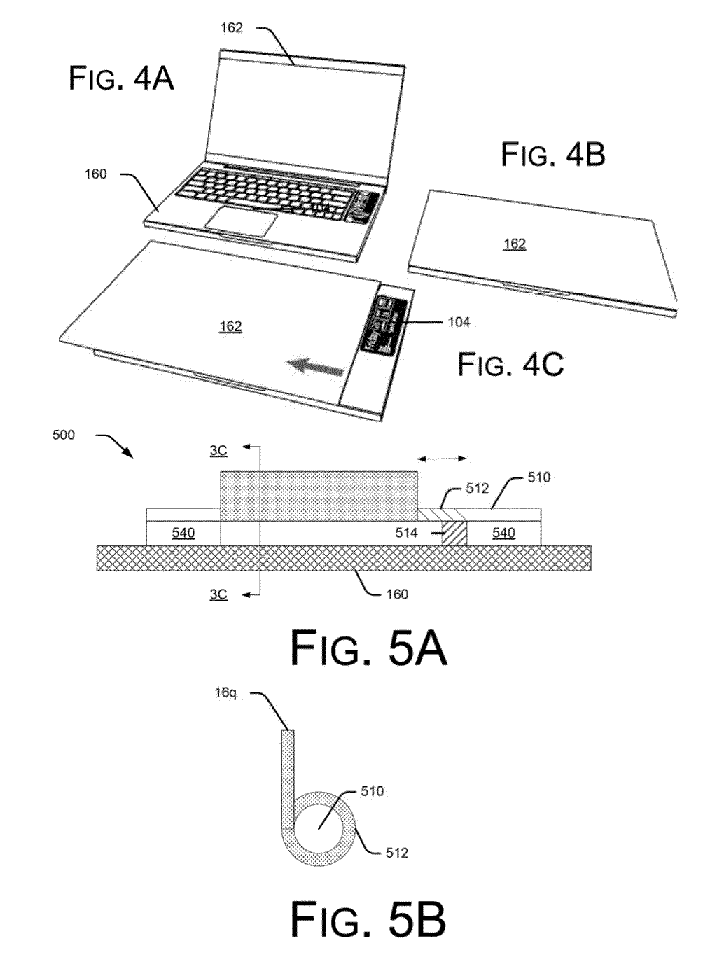

Embodiments of a hinge assembly 166 suitable for use with the embodiments depicted in FIGS. 3A-3C and 4A-4C will be described with reference to FIGS. 2 and FIGS. 5A-5B. FIG. 5A is a schematic, illustration an exemplary hinge assembly 500 which may be used in a clamshell housing of an electronic device, in accordance with some embodiments. Referring to FIGS. 5A-5B, in some embodiments a hinge assembly 500 may comprises a hinge pin 510 mounted to a first section 160 of a housing of the electronic device 108 by a base plate 540. The base plate 540 may be formed from a suitable metal or polymeric material and secured to the first section 160 of the housing using an adhesive or by suitable fasteners, e.g., by set screws, rivets, or the like. The particular technique of securing the base plate 540 to the first section 160 of the housing is not critical.

In some embodiments a portion of the second section 162 of the housing is curved to define a hinge pin cover 512 which wraps around hinge pin 510 such that the second section 162 of the housing can rotate about hinge pin 510 to open and close the housing. Further, as illustrated in FIG. 5A, the hinge pin cover 512 extends only a portion of the distance between base plates 540 to allow the hinge pin cover 512 to translate laterally along the hinge pin 510 between a first position in which the first section 160 and the second section 162 of the housing are aligned and a second position in which the first section 160 and the second section 162 are offset to reveal a portion of the display 104.

In some embodiments the hinge assembly 500 may comprise a bias mechanism such as a compression spring 512 to bias the second section 162 in a position such that the first section 160 and the second section 162 are aligned A releasable latch block 514 may hold the second section 162 in place when it has been translated across the hinge pin 510 to reveal a portion of the display 104. In alternate embodiments a spring blade mechanism that springs to hold the screen in either the open or closed position may be used to secure the alignment of the first section 160 and the second section 162. In further embodiments one or more magnets may be used to align the first section 160 and the second section 162 in both the open and closed position. In further embodiments the hinge assembly 500 is capable of rotational motion only in the first position.

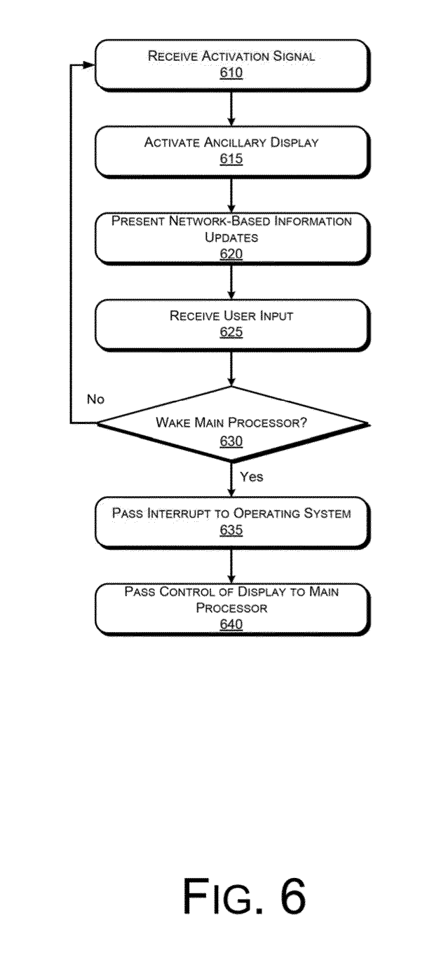

In some embodiments the status update module 176 implements logic to detect when the second section 162 is translated laterally along the hinge pin 510 from the first position to the second position and, in response thereto, to activate the portion of the display 104. FIG. 6 is a flowchart illustrating operations of a controller in a method to implement a display assembly in accordance with some embodiments. In some embodiments the operations depicted in FIG. 6 may be implemented by the status update module 176, alone or in combination with other components executing on the trusted execution complex of the electronic device 108.

Referring to FIG. 6, at operation 610 the controller receives an activation signal. In some embodiments the action signal may be generated when the second section 162 is translated laterally along the hinge pin 510 from the first position to the second position.

In response to the signal, at operation 615, the controller activates the ancillary display on the electronic device 108. By way of example, in some embodiments the status update module 176 may invoke the services of a secure sprite generator 179 to generate a dialog box 280 on a portion of the display 104. In the embodiments depicted in FIGS. 4A-4C the secure sprite generator 179 may activate the secondary display 104. In some embodiments only the dialog box is illuminated, i.e., only the backlight assembly which illuminates the dialog box is activated in order to save power. The dialog box may require a user to log in, as described above with reference to FIG. 2. In alternate embodiments a fingerprint reader might be integrated into the exposed screen bezel so that the user might skip the log-in box. The fingerprint reader will be concealed when the lid is translated to the closed position.

Assuming a successful login, at operation 620 the controller presents at least one network-based information update on the dialog box 280. By way of example, in some embodiments a user may wish to receive notifications of electronic mail received, status updates, stock prices, weather information, or the like, as well as basic system info like battery status, wireless connectivity, and any location based activity. These information updates may be presented on the dialog box for viewing by a user.

At operation 625 the controller receives user input from a user of the electronic device 108. By way of example, in some embodiments a user may indicate that he or she wants to view one or more electronic mails that have arrived, or to otherwise view an information update. If, at operation 630, the user input does not indicate that the main processor needs to be activated then the user may continue interacting with the electronic device 108 via the dialog box 280. Thus, control may pass back to operation 610 and the controller may continue to monitor for signals which indicate that the ancillary display should be activated.

By contrast, if at operation 630 the user input received at operation 625 indicates that the main processor needs to be activated then control passes to operation 635 and the controller passes an interrupt to the operating system 140 to wake the main processor(s) 172 in the untrusted execution complex, and at operation 640 control of the display is passed to the main processor(s) in the untrusted execution complex.

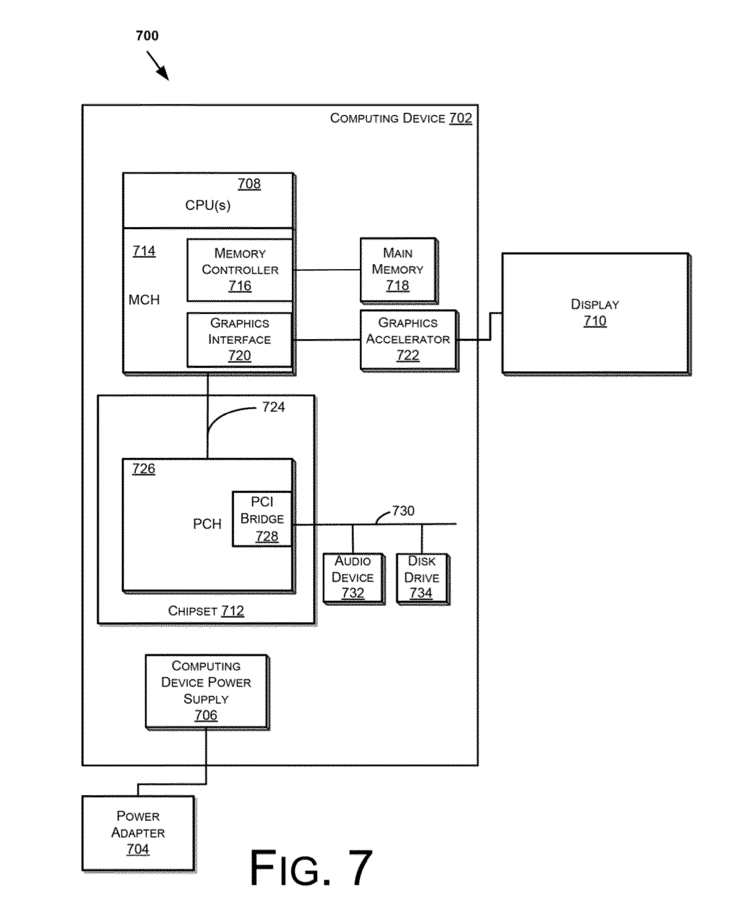

As described above, in some embodiments the electronic device may be embodied as a computer system. FIG. 7 is a schematic illustration of a computer system 700 in accordance with some embodiments. The computer system 700 includes a computing device 702 and a power adapter 704 (e.g., to supply electrical power to the computing device 702). The computing device 702 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 702 (e.g., through a computing device power supply 706) from one or more of the following sources: one or more battery packs, an alternating current (AC) outlet (e.g., through a transformer and/or adaptor such as a power adapter 704), automotive power supplies, airplane power supplies, and the like. In some embodiments, the power adapter 704 may transform the power supply source output (e.g., the AC outlet voltage of about 110 VAC to 240 VAC) to a direct current (DC) voltage ranging between about 5 VDC to 12.6 VDC. Accordingly, the power adapter 704 may be an AC/DC adapter.

The computing device 702 may also include one or more central processing unit(s) (CPUs) 708. In some embodiments, the CPU 708 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON, and Celeron® processors. Also, one or more processors from other manufactures may be utilized. Moreover, the processors may have a single or multi core design.

A chipset 712 may be coupled to, or integrated with, CPU 708. The chipset 712 may include a memory control hub (MCH) 714. The MCH 714 may include a memory controller 716 that is coupled to a main system memory 718. The main system memory 718 stores data and sequences of instructions that are executed by the CPU 708, or any other device included in the system 700. In some embodiments, the main system memory 718 includes random access memory (RAM); however, the main system memory 718 may be implemented using other memory types such as dynamic RAM (DRAM), synchronous DRAM (SDRAM), and the like. Additional devices may also be coupled to the bus 710, such as multiple CPUs and/or multiple system memories.

The MCH 714 may also include a graphics interface 720 coupled to a graphics accelerator 722. In some embodiments, the graphics interface 720 is coupled to the graphics accelerator 722 via an accelerated graphics port (AGP). In some embodiments, a display (such as a flat panel display) 740 may be coupled to the graphics interface 720 through, for example, a signal converter that translates a digital representation of an image stored in a storage device such as video memory or system memory into display signals that are interpreted and displayed by the display. The display 740 signals produced by the display device may pass through various control devices before being interpreted by and subsequently displayed on the display.

A hub interface 724 couples the MCH 714 to an platform control hub (PCH) 726. The PCH 726 provides an interface to input/output (I/O) devices coupled to the computer system 700. The PCH 726 may be coupled to a peripheral component interconnect (PCI) bus. Hence, the PCH 726 includes a PCI bridge 728 that provides an interface to a PCI bus 730. The PCI bridge 728 provides a data path between the CPU 708 and peripheral devices. Additionally, other types of I/O interconnect topologies may be utilized such as the PCI Express® architecture, available through Intel® Corporation of Santa Clara, Calif.

The PCI bus 730 may be coupled to an audio device 732 and one or more disk drive(s) 734. Other devices may be coupled to the PCI bus 730. In addition, the CPU 708 and the MCH 714 may be combined to form a single chip. Furthermore, the graphics accelerator 722 may be included within the MCH 714 in other embodiments.

Additionally, other peripherals coupled to the PCH 726 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 702 may include volatile and/or nonvolatile memory.

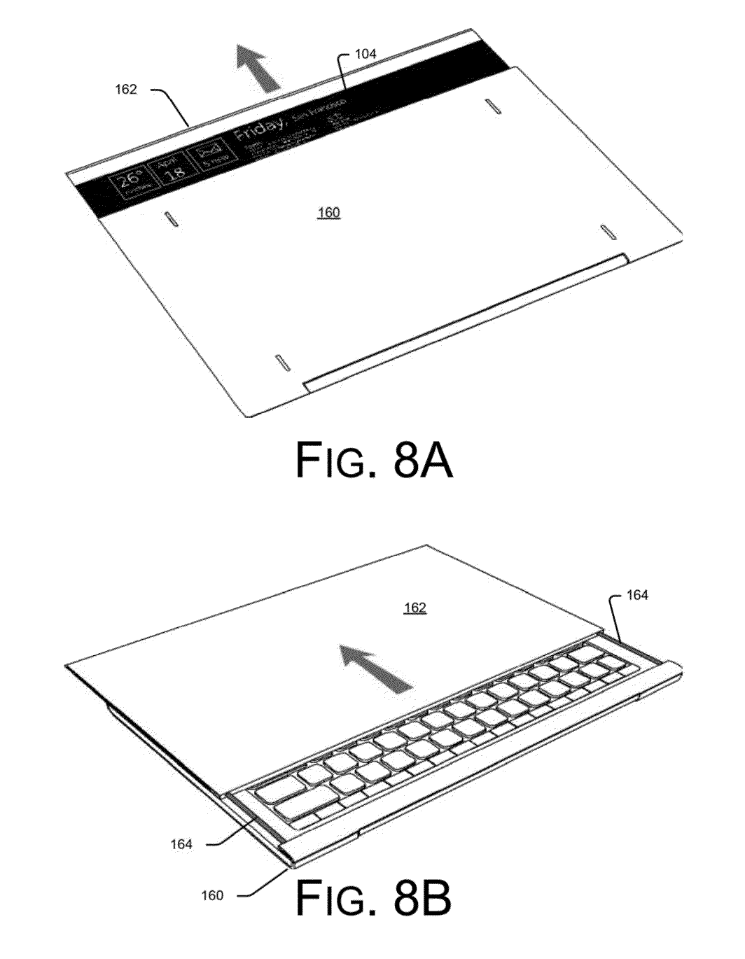

FIGS. 8A and 8B are schematic, perspective views of an electronic device in accordance with some embodiments. In the embodiment depicted in FIGS. 8A and 8B the second section 162 of the electronic device 108 translates longitudinally along an axis that is perpendicular to the axis of the hinge assembly about which the second section 162 rotates. In this embodiment the second section 162 may be configured with a latch mechanism which enables part of the second section 162 to translate laterally on tracks 164 to expose a portion of the display 104.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
a hinge assembly to connect a first section of a housing of an electronic device to a second section of the electronic device, wherein the hinge assembly provides rotational motion between the first section and the second section about a longitudinal axis;
a translation assembly to provides lateral translation of the second section between a first position and a second position, relative to the first section; and
a controller to:
detect lateral translation of the second section of the housing from the first position to the second position; and
in response thereto, to activate an ancillary display device coupled to the housing.

2. The apparatus of claim 1, wherein the translation assembly enables lateral translation of the second section along the longitudinal axis between the first position and the second position, and further comprising:
a bias mechanism to bias the second section in the first position; and
a latch mechanism to retain the second section in the second position.

3. The apparatus of claim 1, wherein the translation assembly enables lateral translation of the second section along an axis perpendicular to the longitudinal axis between the first position and the second position, and further comprising:
a bias mechanism to bias the second section in the first position; and
a latch mechanism to retain the second section in the second position.

4. The apparatus of claim 1, wherein the controller comprises logic to:
generate a dialog box on a portion of a display coupled to the second section; and
present, in the dialog box, at least one network-based information update.

5. The apparatus of claim 4, wherein only the portion of the display which contains the dialog box is illuminated.

6. The apparatus of claim 4, wherein the controller comprises logic to:
receive, in the dialog box, a user input;
determine whether the user input requires activation of the entire display; and
in response to a determination that the user input requires activation of the entire display, generate a signal to activate the entire display.

7. The apparatus of claim 1, wherein the controller comprises logic to:
detect lateral translation of the second section of the housing from the second position to the first position; and
in response thereto, to deactivate the ancillary display device coupled to the housing.

8. The apparatus of claim 1, wherein the hinge assembly is capable of rotational motion only in the first position.

9. The apparatus of claim 1, wherein the ancillary display is a touch-sensitive display.

10. The apparatus of claim 2, wherein the bias mechanism comprises at least one of a spring or a magnet.

11. An electronic device, comprising:
a housing having a first section and a second section comprising a display, the second section coupled to the first section by a hinge assembly a hinge assembly, wherein the hinge assembly provides rotational motion between the first section and the second section about a longitudinal axis;
a translation assembly to provide lateral translation of the second section between a first position and a second position, relative to the first section;
a processor to execute an operating system; and
a controller to:
detect lateral translation of the second section of the housing from the first position to the second position; and
in response thereto, to activate an ancillary display device coupled to the housing.

12. The electronic device of claim 11, wherein the translation assembly enables lateral translation of the second section along the longitudinal axis between the first position and the second position, and further comprising:
a bias mechanism to bias the second section in the first position; and
a latch mechanism to retain the second section in the second position.

13. The electronic device of claim 11, wherein the translation assembly enables lateral translation of the second section along an axis perpendicular to the longitudinal axis between the first position and the second position, and further comprising:
a bias mechanism to bias the second section in the first position; and
a latch mechanism to retain the second section in the second position.

14. The electronic device of claim 11, wherein the controller comprises logic to:
generate a dialog box on a portion of a display; and
present, in the dialog box, at least one network-based information update.

15. The electronic device of claim 14, wherein the controller comprises logic to:
receive, in the dialog box, a user input;
determine whether the user input requires activation of the entire display; and
in response to a determination that the user input requires activation of the entire display, generate a signal to activate the entire display.

16. The electronic device of claim 11, wherein the controller comprises logic to:
detect lateral translation of the second section of the housing from the second position to the first position; and
in response thereto, to deactivate the ancillary display device coupled to the housing.

17. The electronic device of claim 11, wherein the controller comprises logic to:
generate a dialog box on an ancillary display separate from the display; and
present, in the dialog box, at least one network-based information update.

18. The electronic device of claim 11, wherein the controller is a component of a trusted execution complex.

19. A computer program product comprising logic instructions stored on a tangible computer readable medium which, when executed by a controller, configure the controller to:
monitor a translation assembly which provides translational motion between a first section of a housing and a second section of the housing about a longitudinal axis and further provides lateral translation of the second section between a first position and a second position, relative to the first section
detect lateral translation of the second section of the housing from the first position to the second position; and
in response thereto, to activate an ancillary display device coupled to the housing.

20. The computer program product of claim 19, further comprising logic instructions stored on a tangible computer readable medium which, when executed by a controller, configure the controller to:
generate a dialog box on a portion of a display; and
present, in the dialog box, at least one network-based information update.

21. The computer program product of claim 20, further comprising logic instructions stored on a tangible computer readable medium which, when executed by a controller, configure the controller to:
receive, in the dialog box, a user input;
determine whether the user input requires activation of the entire display; and
in response to a determination that the user input requires activation of the entire display, generate a signal to activate the entire display.

22. The computer program product of claim 19, further comprising logic instructions stored on a tangible computer readable medium which, when executed by a controller, configure the controller to:
detect lateral translation of the second section of the housing from the second position to the first position; and
in response thereto, to deactivate the ancillary display device coupled to the housing.

23. The computer program product of claim 19, further comprising logic instructions stored on a tangible computer readable medium which, when executed by a controller, configure the controller to:
generate a dialog box on an ancillary display separate from the display; and
present, in the dialog box, at least one network-based information update.

24. A controller, comprising:
logic configured to:
monitor a translation assembly which provides rotational motion between a first section of a housing and a second section of the housing about a longitudinal axis and further provides lateral translation of the second section between a first position and a second position, relative to the first section
detect lateral translation of the second section of the housing from the first position to the second position; and
in response thereto, to activate an ancillary display device coupled to the housing.

25. The controller of claim 24, wherein the logic is further configured to:
generate a dialog box on a portion of a display; and
present, in the dialog box, at least one network-based information update.

26. The controller of claim 24, wherein the logic is further configured to:
receive, in the dialog box, a user input;
determine whether the user input requires activation of the entire display; and
in response to a determination that the user input requires activation of the entire display, generate a signal to activate the entire display.

27. The controller of claim 24, wherein the logic is further configured to:
detect lateral translation of the second section of the housing from the second position to the first position; and
in response thereto, to deactivate the ancillary display device coupled to the housing.

28. The controller of claim 24, wherein the logic is further configured to:
generate a dialog box on an ancillary display separate from the display; and
present, in the dialog box, at least one network-based information update.
